(19) United States
(12) Patent Application Publication
(10) Pub. No.: US 2013/0333425 A1
(43) Pub. Date: Dec. 19, 2013

(54) DOUBLE LOCKING HANDCUFFS

(71) Applicant: SCOTT GREGORY KRELLE, Chico, CA (US)

(72) Inventor: SCOTT GREGORY KRELLE, Chico, CA (US)

(21) Appl. No.: 13/527,545

(22) Filed: Jun. 19, 2012

(51) Int. Cl. E05B 75/00

(52) U.S. Cl. 70/16

(57) ABSTRACT

A set of double locking handcuffs wherein a single cuff has a frame that is a solid member, having an ergonomic base and a single arcuate arm, to which an opposite-facing arcuate swing arm is pivotally affixed at the top of the arm that rotates parallel to the frame in a bypass manner without a mechanical union with the base of the frame. At the top of the swing arm at the pivot point is the housing, having the gear, pawl, and lock assembly disposed in its cavity. The gear's circumference has both ratcheting and smooth surfaces that cooperate with the pawl. The lock assembly comprises a keyway that is configured to cooperate with protrusions within the cavity to prevent defeat of the cuff. The housing of one cuff is at the opposite axial end of the housing of the adjoining cuff when the set is extended outward.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The present invention relates to manacles, restraint systems, and handcuffs. The described handcuffs are designed to facilitate the handcuffing of an individual.

Manacles, shackles, and handcuffs are portable locking devices used by law enforcement and custodial personnel to temporarily but securely detain suspects or persons in their custody. These comprise a pair of shackles joined together so that the wrists or ankles of a prisoner are secured to one another. The modern handcuff design has proven to be functional and has changed very little for decades.

One typical design for conventional handcuffs is shown in U.S. Pat. No. 4,287,731. In the '731 patent, a pivoting, curvilinear jaw with ratcheting teeth moves downward into the cavity of the handcuff frame, also known as the cheek plates, and against a pawl with opposing and cooperating ratcheting teeth. In this manner, the pawl-and-ratchet mechanism permits one way rotational movement of the jaw. The jaw may continue downward, but spring pressure atop the pawl prevents the jaw from upward movement.

The downward movement of the jaw is generally and typically produced by the momentum of the jaw itself as the cuff is applied to the wrist of the subject. Standardized training in the use and application of handcuffs reinforces this reliance on the jaw's momentum and probability that the unobstructed jaw will continue to the cavity of the frame, contacting the opposing teeth of the pawl. If the jaw's momentum is not enough to drive it to the frame and contact the pawl, or if the jaw's momentum is slowed or stopped by an obstruction in its path, e.g., clothing, skin, wrist watch, jewelry, the cuff will remain in an open position and not lock. Until manually pushing the jaw downward and/or clearing the obstruction then pushing the jaw downward into the cavity, the cuff is ineffective. Subsequently, there are more incidents than not when the jaw of the cuff does not contact with the pawl and lock or an obstruction needs to be cleared prior to applying the cuff, requiring extra effort and crucial restraint time to effect a detention. Due to the mandatory marriage of the pivoting jaw with the cavity of the handcuff frame, the handcuffs can be difficult to apply, particularly when the subject being detained is uncooperative, has bulky clothing, or is large in stature.

The conventional handcuff is comprised of two planar, parallel, curvilinear cheek plates that are identical and opposed and a lock housing at the bottom to form a frame. A pin at the top of the cheek plates attaches to the top of a curvilinear arm or jaw, which rotates in a circular motion parallel to and between the two cheek plates. Between the cheek plates at the top of the lock housing is a cavity which the jaw passes through. In this cavity is an exposed pawl, which has ratchet teeth opposing the teeth at the bottom of the jaw. Accordingly, the inner surfaces on the cheek plates, the teeth of the jaw, and the cavity on the top of the lock housing are not easily accessible for cleaning and disinfecting after detaining a subject who potentially has a hazardous disease, or after blood or other bodily fluid had been transferred to the cuff.

The conventional handcuff has a locking mechanism that requires a conventional handcuff key. The keyhole has a protruding post in the center and is shaped specifically to accept the handcuff key, which is designed to prevent other objects from fitting into the keyhole. Once the handcuff key is inserted, a simple rotation of the key will release the cuff. The release is accomplished by using the bit of the key to move the spring-loaded ratcheting teeth of the pawl within the frame, separating them from the opposing teeth of the pivoting jaw. If the cuff has been double locked, the key is first rotated in one direction to disengage the lock, then rotated in the opposite direction to enable the release. However, due to the lack of further defensive measures to ensure the integrity of the lock, this simple and somewhat primitive design has proved to be inadequate protection against disabling or unlocking the mechanism with a small object or instrument. Furthermore, the modern handcuff can be defeated by sliding a flat instrument from outside the cuff to an area between the pawl and jaw, disengaging the opposing teeth. There are currently a multitude of public online videos and websites that reveal and instruct simple methods for defeating conventional handcuffs with common objects.

Additionally, the keyhole of a conventional handcuff is located at the bottom of the cheek plates in the mechanical space of the frame, nearest the connecting chain. When the handcuffs are restraining a subject, this location places the keyholes in an unwieldy and awkward location in the confined space between the wrists of the subject. Releasing the handcuffs, which are typically worn behind the subject's back, can be a problematic task and frequently causes distress to a presumably cooperative subject while the cuffs are removed, and also can place the officer or other user in a potentially dangerous stooped position behind the subject.

With the conventional handcuff, the cuffs can be double locked to prevent any further downward movement of the pivoting jaw once joined with the opposing teeth within the frame, thus preventing further tightening of the cuff around the subject's wrist. There are different variations of this double locking mechanism. In the '731 patent, the small, pin-like protuberance of a typical handcuff key is inserted into a slot in the cuff frame, then moved left to right to prevent movement of the bolt away from the jaw. In U.S. Pat. No. 5,660,064, the same small end of the handcuff key is inserted into a small bore or hole in the frame of the cuff, moving a bolt to block the pawl's movement away from the jaw. Both methods are accomplished at the bottom of the frame nearest the subject's wrists and connecting chain. Additionally, both methods require using the very small end of the handcuff key, nearest the user's grasping point of the key. Double locking a modern handcuff can prove difficult or dangerous in low light conditions or with a combative subject and hazardous if there is blood or other bodily fluid in the area of the cuff.

Accordingly, the intent of the present invention is to alleviate the aforementioned safety and health concerns that are common in the conventional handcuff design. The invention is an improved handcuff with the objectives that it is easier to apply on a subject, easier to release due to the location and operation of the keyhole and related mechanism, and is not defeatable by overtly advertised methods. Additionally, the invention is an improved handcuff with the objectives to have a double locking mechanism that gives positive tactile feedback and is both easily and safely engaged, and a handcuff that has surfaces without crevices and uncleanable areas. Using fewer parts and simple construction, the invention may also be less expensive to produce and equip law enforcement or other custodial personnel.

### BRIEF SUMMARY OF THE INVENTION

In its various aspects, an embodiment of the invention provides improved handcuffs and a preferred method for their use. Generally stated, it consists of a solid frame, a solid swing arm with a housing containing mechanical components within its cavity, a gear, a housing cover, and a chain with a swivel at either end, connecting two handcuffs together.

The frame is a solid curvilinear plate that has a base and an arcuate arm, forming one side of the cuff. The base is wider than the width of the arm, and has an arc at the top defined by the radius of the swing arm as it pivotally passes the frame. A swivel is affixed to the bottom of the base at the axis. From the back edge of the base extends the curvilinear arm upward.

The swing arm is a solid curvilinear plate that forms the other side of the cuff. The bottom of the swing arm has a slight curvature in the opposite and outward direction, allowing the user to extend the index finger from the pistol grip position and pull the swing arm toward the base of the frame, thus tightening the cuff using one hand in its original position of control. There is a housing at the top of the swing arm, the cavity of which is the machinery space containing the pawl, pawl spring, lock assembly, and frame gear when assembled. The keyhole is located on the outer surface of the housing. There are two small protuberances inside the cavity surrounding the keyhole, wherein a spur of the keyway seats between or beyond them to prevent defeat of the cuff and unintended rotation of the keyway. The protuberances are identified as the outer and inner stops, and their function is to isolate the keyway in specific locations around the pawl, designated as the stored position, double locked position, and the releasing position. A hinge shaft protrudes perpendicularly outward from the cavity plate that connects the assembled swing arm to the frame through the gear. The swing arm pivots at the shaft in parallel with the plane of the frame and rotates in a bypass, circular motion.

Affixed to the pivot point of the frame is a gear that cooperates with the pawl and is perpendicular to the plane of the frame. The gear's circumference has ratcheting teeth and a smooth surface, allowing the swing arm unidirectional rotation when ratcheting and free rotation in either direction when not ratcheting. The smooth circumference allows the swing arm to rotate swiftly with little resistance from the pawl when the cuff is first applied and the arm is rotating prior to encircling the subject's wrist. The gear is pivotally disposed within the cavity of the housing when assembled.

The pawl is pivotally disposed inside the cavity of the housing. The contour of the sides of the pawl is to some extent egg shaped, with the teeth on the smaller end and the pivot point in the center of the larger end. A cylindrical bore is centered at the pivot point in which the keyway will be disposed. The height of the pawl is significantly decreased in a half-circle sector of the pawl, opposite the pivot point from the teeth and surrounding the bore. This region accommodates rotation of the keyway spur within that sector, which cooperates with the stops of the pawl on either side of the bore. The stops are identified as the locking and release stops, and are a product of the sector's reduction in height. A flat spring sits behind the pawl and directs pressure against the pawl toward the gear. The teeth of the pawl face and cooperate with the radius and teeth of the frame gear, allowing the housing and swing arm to ratchet unidirectional. When the teeth of the pawl are in contact with the smooth surface area of the gear, the housing and swing arm may move freely in either direction.

The lock assembly consists of a keyway, spring washer, and pin. The keyway is a hollow cylinder pivotally disposed within the bore of the pawl and perpendicular to the housing cavity plate, wherein the inside diameter of the keyway accepts the shaft of a conventional handcuff key. The keyway sits directly beneath the keyhole, and has an open sector for the bit of the handcuff key to enter and rotate within the cylinder and operate the lock. A spring washer is disposed within the bore of the pawl and biases the base of the keyway. In this manner, the top of the keyway cylinder is in contact with the underside of the housing at the keyhole, preventing small instruments or objects to enter the mechanical space through the keyhole and manipulate the pawl. The outer surface of the keyway cylinder has one protruding spur extending outward into the housing cavity. The spur cooperates with the outer and inner stops of the housing to impede tampering and movement, and also cooperates with the pawl stops, effecting the double lock and release of the cuff. From the stored position, when the keyway is depressed with the key and rotated 90 degrees away from the pivot point, the spur prevents movement of the pawl away from the gear and accordingly double locks the cuff. From either the double locked or stored position, when the key is rotated 180 degrees in the opposite direction, the subsequent rotation of the keyway causes the spur to contact and drive the pawl away from the gear and releases the cuff.

The housing cover is fastened over the open swing arm housing cavity, forming a plate of the cavity and providing security for the mechanical components. It comprises a circular opening for the frame gear and a protruding pin to enter the hollow shaft of the handcuff key. The pin extends through the axis of the keyway and keyhole opening.

The preferred application and releasing of the embodiment uses the same fundamental procedures as conventional handcuffs and exemplifies techniques taught through standardized training methods. With the cuff in a stored position, the user grasps the base of the frame in a position of control. The base of the cuff's frame is wider than the arm and ergonomically shaped so the user preferably employs a “pistol grip” grasp, using the crux of the web of the hand between the thumb and index finger on the back of the base and crux of a joint of the middle finger on the front of the base, allowing for enhanced cuff control upon application. The user then pushes the apex of the swing arm against the subject's wrist. As sustained force is applied, the ratcheting teeth of the pawl disposed within the swing arm housing cooperate with the teeth of the gear, and the swing arm rotates unidirectional around the gear. As the subject's wrist drives the swing arm further in the direction of the frame, the teeth of the pawl shift onto the smooth circumference of the gear. The swing arm then rotates freely around the subject's wrist by its momentum until the teeth of the pawl reunite with the teeth of the gear, at which point the swing arm and frame are nearly encompassing the wrist and the cuff is capable of temporary restraint without a union of the two arms at the opposite end of the hinge point. When properly applied, momentum preferably should continue to ratchet the swing arm near the point of contact with the wrist. If the cuff needs to be tighter around the wrist for suitable restraint, the user applies pressure with their index finger to the bottom curvature of the swing arm and pulls it closer to the subject's wrist until proper restraint is achieved.

Double locking the handcuff uses a conventional handcuff key, but is accomplished in a much more accessible location to the outside of the subject's wrist. Once the key is inserted into the keyway, downward pressure parallel with the shaft of the key is applied, compressing the spring washer housed under the keyway. This lowers the keyway spur below the outer stop on the inside of the housing and allows the keyway to rotate. The key is then rotated away from the pivot point of the cuff 90 degrees until the spur contacts the locking stop on the pawl, preventing the pawl's movement away from the gear. When downward pressure is released, the keyway returns to a raised position via the spring washer, and the spur of the keyway seats beyond the outer stop in the double locked position. Rotation of the key back 90 degrees within the open sector of the keyway will allow removal of the key through the keyhole.

Releasing the handcuff uses a conventional handcuff key and is performed much in the same manner as the double locking procedure. The key is inserted into the keyway and downward pressure is applied, compressing the spring washer and lowering the keyway spur below the outer stop of the housing. Rotating the key toward the pivoting point of the cuff 90 degrees while maintaining downward pressure moves the spur from blocking the pawl and disengages the double lock. Continuing the key rotation another 90 degrees will contact the spur with the releasing stop of the pawl, pivoting it away from the gear and releasing the cuff. Preferably, the user would apply continuous downward pressure and make one fluid 180 degree rotation to release the cuff.

### BRIEF DESCRIPTION OF THE SEVERAL VIEWS OF THE DRAWINGS

Features, characteristics, and advantages of the present invention will appear more clearly with respect to the following descriptions, appended claims, and accompanying drawings:

FIG. 1 is a plain view of a single handcuff of one embodiment. The plate of the housing is omitted in order to view the components of the mechanical space within the housing;

FIG. 2 is a sectional view of the housing shown in FIG. 1, indicated by a dashed circle;

FIG. 3A is a plain view of a single handcuff;

FIG. 3B is a plain view of the handcuff in FIG. 3A rotated on its axis 90 degrees clockwise;

FIG. 3C is a plain view of the handcuff in FIG. 3A rotated on its axis 180 degrees;

FIG. 3D is a plain view of the handcuff in FIG. 3A rotated on its axis 90 degrees counterclockwise;

FIG. 4A is a plain view of the swing arm housing, absent of the mechanical components within the cavity;

FIG. 4B is a sectional view of FIG. 4A, taken in the direction of cut line 4B-4B;

FIG. 5A is a plain view of the underside of the housing cover;

FIG. 5B is a sectional view of FIG. 5A, taken in the direction of cut line 5B-5B;

FIG. 6A is a plain view of the swing arm housing, with the plate of the housing omitted, indicating the direction of the keyway in the stored position;

FIG. 6B is a plain view of the swing arm housing, with the plate of the housing omitted, indicating the direction of the keyway in the double locked position;

FIG. 6C is a plain view of the swing arm housing, with the plate of the housing omitted, indicating the direction of the keyway in the releasing position;

FIG. 7A is an exploded perspective view of the keyway, spring washer, and pawl;

FIG. 7B is a perspective view of FIG. 7A subsequent to assembly, and includes the cylindrical pin that passes through the handcuff key shaft;

FIG. 7C is a perspective view of FIG. 7B, with a cutaway view of the housing plate atop the assembly;

FIG. 8A is a perspective view of the hinge area with a cutaway of the housing wall to expose the components within the mechanical space

FIG. 8B is a perspective view of the hinge area represented in FIG. 8A.

FIG. 9 is an exploded view of the complete assembly for one handcuff, representing a transparent housing of the swing arm;

FIG. 10A is a plain view of a single handcuff of an alternative embodiment;

FIG. 10B is a plain view of the handcuff in FIG. 10A rotated on its axis 90 degrees clockwise;

FIG. 10C is a plain view of the handcuff in FIG. 10A rotated on its axis 180 degrees; and

FIG. 10D is a plain view of the handcuff in FIG. 10A rotated on its axis 90 degrees counterclockwise.

### DETAILED DESCRIPTION OF THE INVENTION

A set of two handcuffs are identical, excluding that the components of each are oppositely constructed and assembled, consequently creating a mirror image of each other. Each component of opposing cuffs, accordingly, shares the same reference numeral, and one applies to the other.

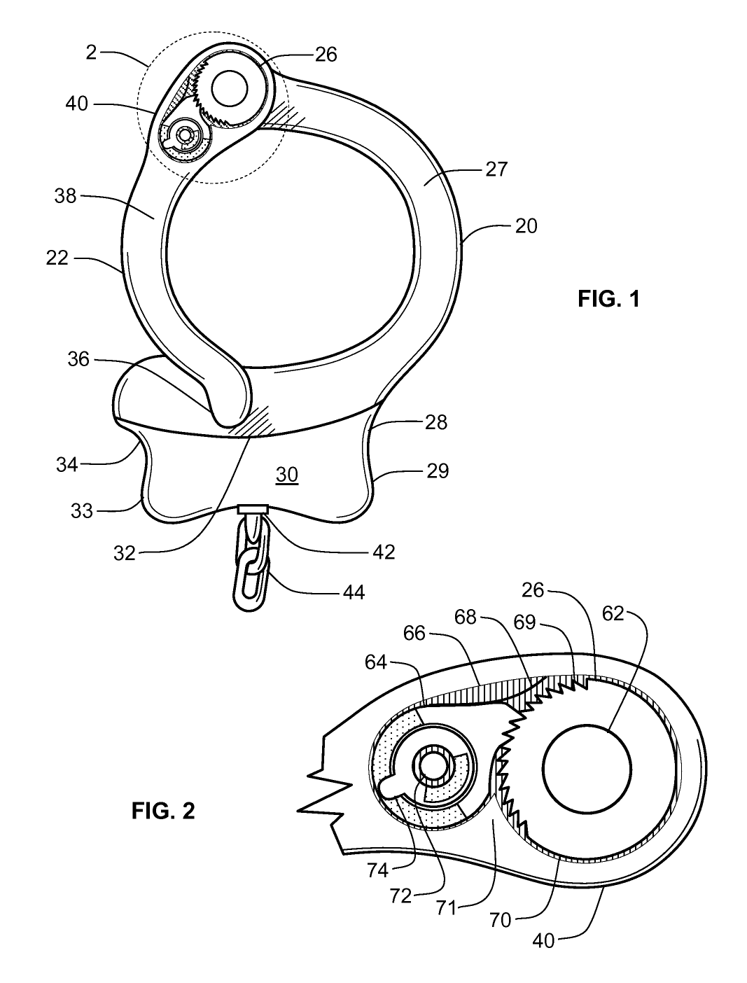

With reference to FIGS. 1-9, an embodiment of the invention is shown.

Referring to FIG. 1, a single cuff is shown comprising frame 20 and swing arm 22. A chain 44 links two cuffs together by means of attached swivel 42 in a conventional manner. The frame 20 is comprised of arcuate arm 27 and base 30. The base 30 of frame 20 is wider than that of arm 27 for an improved grasp in a position of control. The base 30 is also ergonomically designed to fit the user's hand in a pistol grip position by means of rear curvilinear surface 28 and protrusion 29 below, and forward curvilinear surface 34 and protrusion 33 below. The top edge of base 30 is an arc 32 that emulates the radius of swing arm 22 as it traverses frame 20. The gear 26 is affixed to the top of arm 27 of frame 20 at the pivot point.

The swing arm 22 is comprised of housing 40 and arcuate arm 38. The arm 38 has curvilinear tab 36 that provides the user with a lever to tighten the cuff with the index finger while maintaining a controlled grip. The housing 40 is comprised of a cavity 66 which has a shaft 62 extending perpendicularly outward from the inside plane of housing 40. The cavity 66 defines the machinery space of the cuff. The bottom plate of housing 40 in FIG. 1 is not shown to reveal the machinery space and its components, shown in FIG. 2 as keyway 74, pawl 64, spring 68, gear 26, and pin 72.

The keyway 74 is a hollow cylinder that is pivotally disposed within the cylindrical bore of pawl 64 that accepts the shaft of a conventional handcuff key.

The pawl 64 is pivotally disposed within housing 40 and rotates within cavity 66, held in place by the surrounding wall of cavity 66 and wall indent 71. The pawl 64 cooperates with ratchet teeth 69 and smooth plane 70 of the circumference of gear 26. The pawl 64 and keyway 74 share a corresponding axis.

The pawl spring 68 is comprised of a bowed thin metal that is configured for applying lateral bias to pawl 64 against gear 26.

The gear 26 is disposed into housing 40 when frame 20 is assembled with swing arm 22, and is surrounded partly by the wall of cavity 66. The gear 26 has a cylindrical bore that accepts housing shaft 62, wherein shaft 62 is pivotally disposed when assembled through gear 26 and frame 20. The shaft 62 is then pivotally machined or pressed about frame 20 upon assembly, whereas the tolerance allows for free rotation of swing arm 22.

The small cylindrical pin 72 extends through the center of the hollow bore of keyway 74, and enters the hollow shaft of a conventional handcuff key when the key is placed into keyway 74.

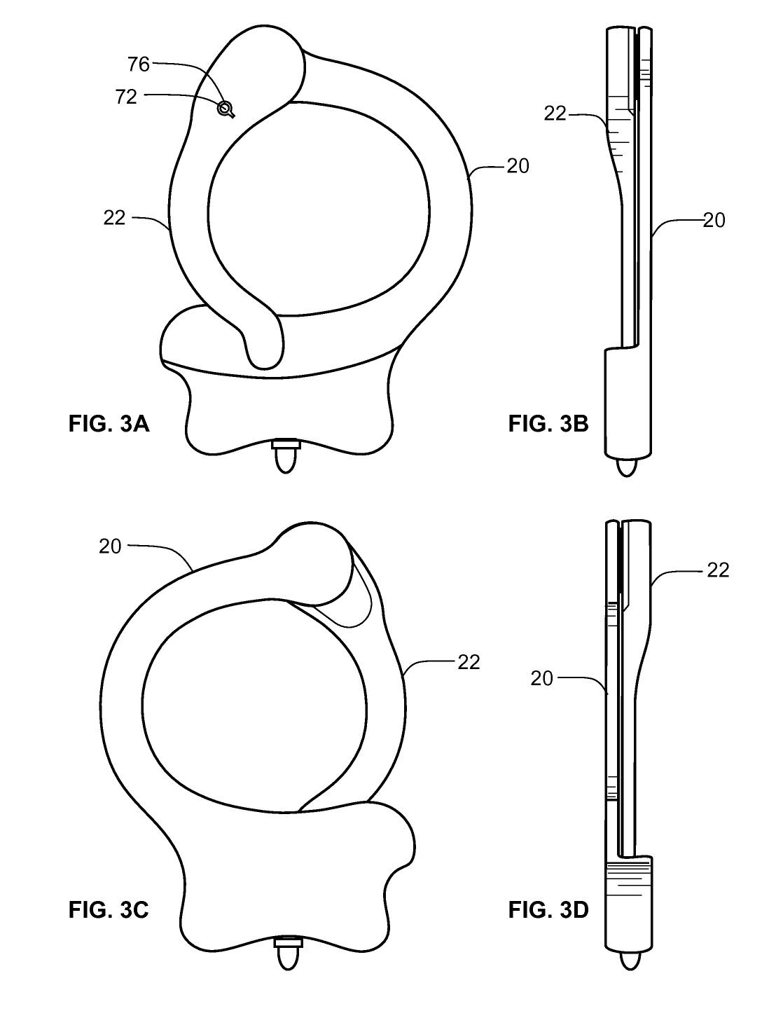

With reference to FIGS. 3A-3D, a single handcuff is shown at various angles. In FIG. 3A, the location of keyhole 76 and pin 72 are shown. It is noteworthy that the location outside the subject's wrist provides for unproblematic access to keyhole 76 when double locking and releasing the cuff. FIG. 3B shows the cuff in FIG. 3A rotated 90 degrees clockwise, wherein the bypass element of swing arm 22 to frame 20 is shown. FIG. 3C shows the opposite side of the cuff shown in FIG. 3A, wherein frame 20 is atop swing arm 22, and FIG. 3D shows the cuff in FIG. 3A rotated 90 degrees counterclockwise, wherein the bypass element of swing arm 22 and frame 20 is again shown.

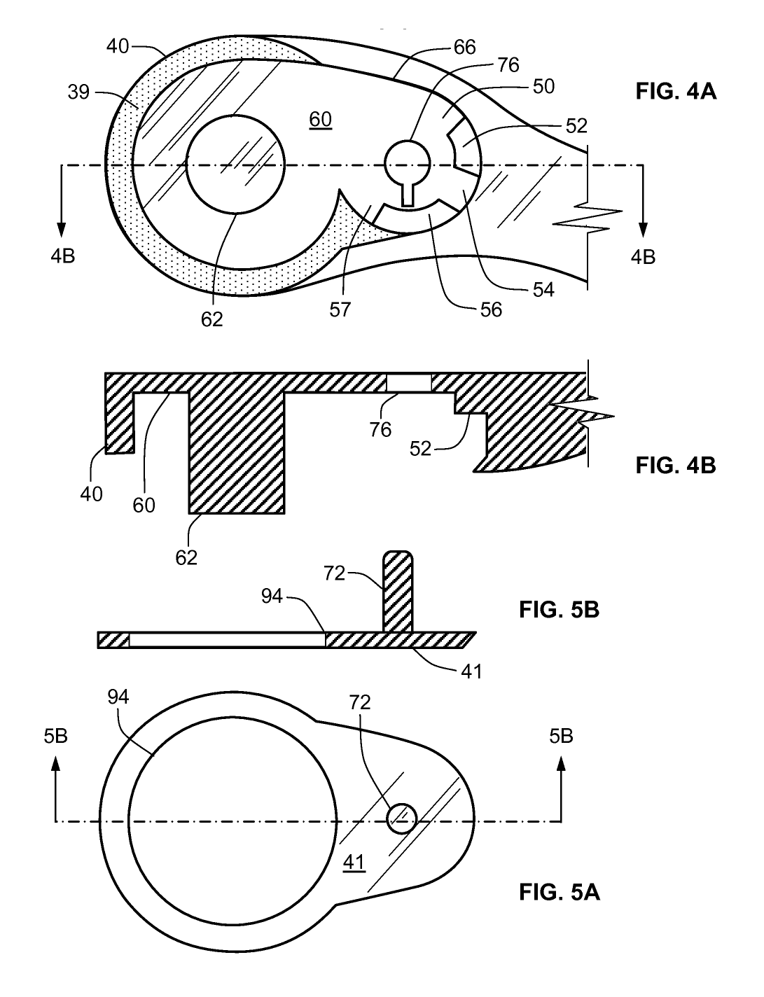

With reference to FIGS. 4A-4B, housing 40 of the swing arm is shown, wherein cavity 66 is void of the mechanical components. On inner cavity plate 60 of housing 40 is the cylindrical housing shaft 62 that perpendicularly extends outward from cavity 66 beyond the plane of cavity 66 opening. The keyhole 76 is also located on plate 60 of housing 40, centered on the axis of the smaller semi cylindrical wall of cavity 66. Around keyhole 76 with corresponding radiuses are sectors and protuberances that cooperate with the keyway to prevent unintended movement of the keyway. The center sector 54 of plate 60 defines the area of the stored position, with protuberances outer stop 52 and inner stop 56 on either side. The outer sector 50 defining the area of the double locked position is beyond outer stop 52, and inner sector 57 defining the area of releasing is beyond inner stop 56. The plate recess 39 at the opening of cavity 66 is indicated by stippling and is stepped down, allowing for the housing cover shown in FIG. 5A to seat flush with the outer plate of housing 40. The location and perspective of the cross section in FIG. 4B is indicated by a section line in FIG. 4A.

Referring to FIGS. 5A-5B, housing cover 41 is shown. The cover 41 is joined to housing 40 after the mechanical components are disposed within cavity 66, and seats in plate recess 39. The gear shown in FIG. 2 is rotatably positioned on shaft 62 through cover opening 94. The pin 72 extends perpendicularly from the plate of cover 41 and is centered within keyhole 76, flush with the planar surface of the outer plate of housing 40. The location and perspective of the cross section in FIG. 5B is indicated by a section line in FIG. 5A.

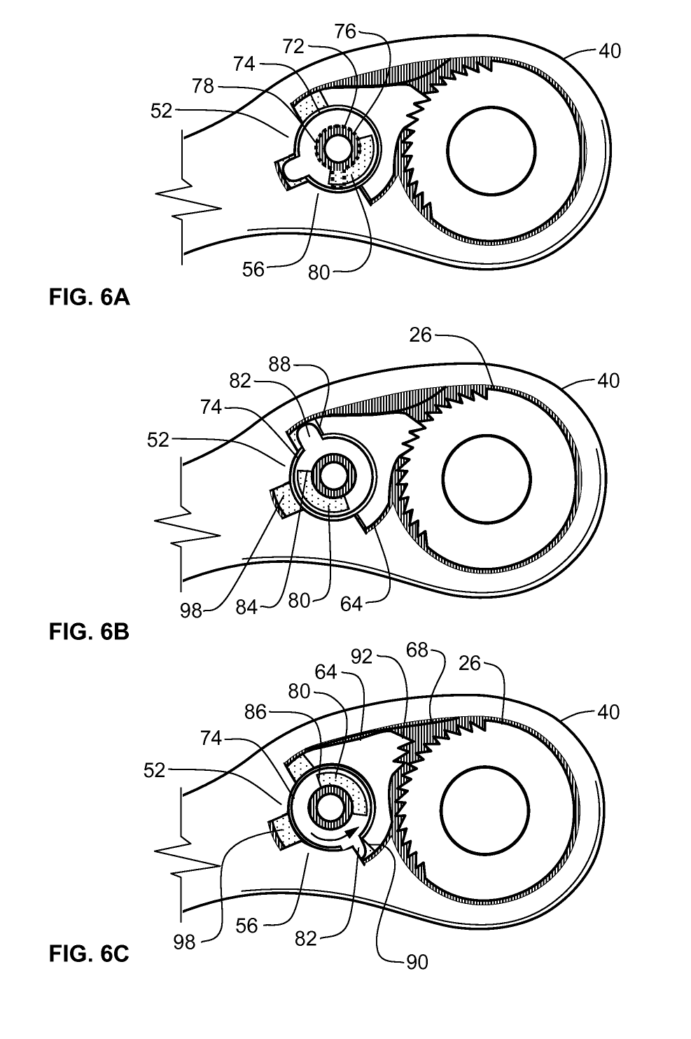

With reference to FIGS. 6A-6C, housing 40 is shown absent of the bottom plate to reveal the mechanical space, and outer stop 52 and inner stop 56 are shown. FIG. 6A indicates the position of keyhole 76 by a broken line over keyway 74, which is shown in the stored position, or moreover, a position where keyway 74 is not influencing the operation of the cuff. In this position, keyway spur 82 is seated between outer stop 56 and inner stop 52 against the inside plate of housing 40. Once the cuff is applied onto a subject's wrist, a conventional handcuff key is used to operate the keyway. To double lock, the user inserts the key into keyhole 76, allowing pin 72 to enter the hollow shaft of the key. The shaft enters cylindrical opening 78 of keyway 74, and the bit of the key enters open sector 80 of keyway 74. Referring to FIG. 6B, the user applies downward force to the key, lowering spur 82 of keyway 74 below outer stop 52. Rotation of the key away from the pivot point of housing 40 above lower step 98 of pawl 64 contacts the bit of the key with stop 84 of keyway 74, and a 90 degree turn positions spur 82 against locking stop 88 of pawl 64. Releasing the downward force raises spur 82 beyond outer stop 52, preventing the pivotal movement of pawl 64 and subsequently double locking the cuff. The key can then be rotated back 90 degrees within open sector 80 and removed. Referring to FIG. 6C, the cuff is released by applying downward force and rotating the bit of the inserted key in open sector 80 toward the pivot point of housing 40. The rotation of the key above lower step 98 of pawl 64 contacts the bit with stop 86 of keyway 74, and the downward force permits spur 82 to travel below outer stop 52 and inner stop 56, and against release stop 90 of pawl 64. Further rotation of the key will pivot pawl 64 against the bias of pawl spring 68, separating teeth 92 of pawl 64 from gear 26, allowing for free rotation. An arrow is shown, indicating the rotation of keyway 74.

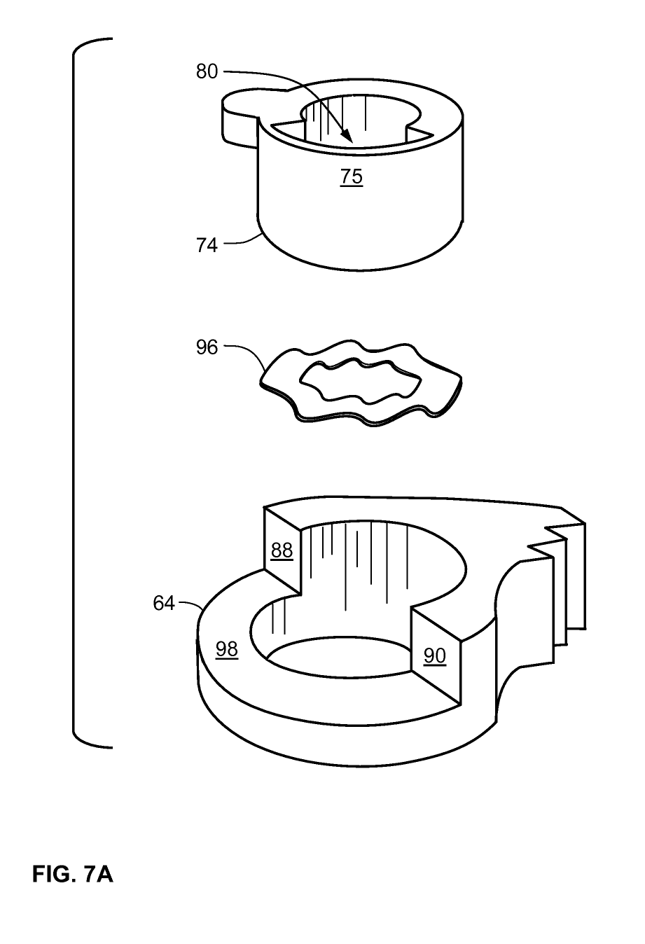

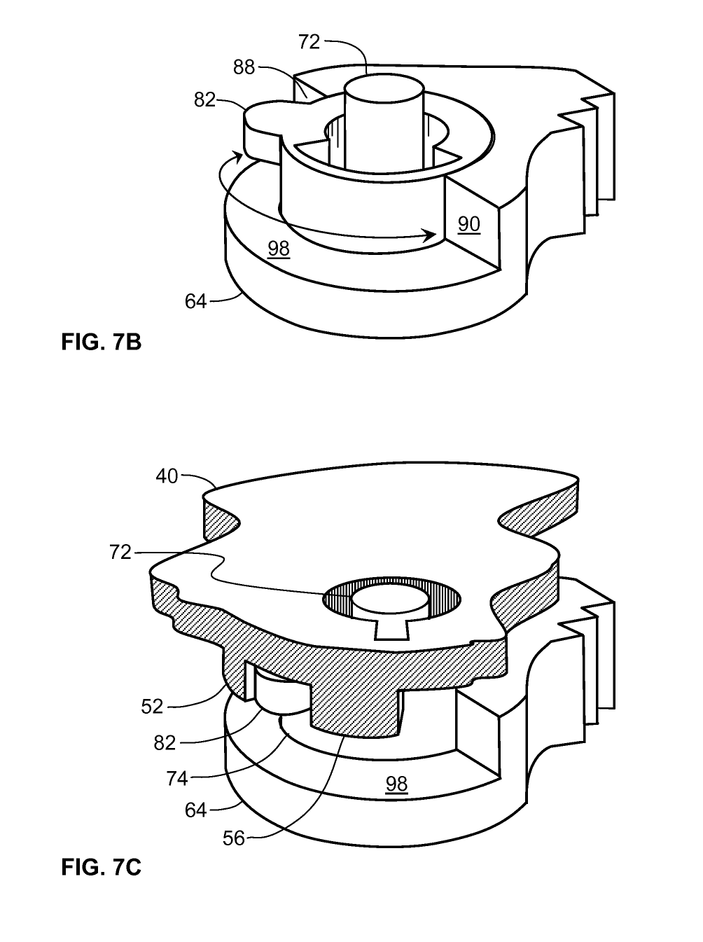

Referring to FIGS. 7A-7C, keyway 74, spring washer 96, and pawl 64 are shown in an exploded view in their position of assembly in FIG. 7A. Also shown is the solid outer circumference 75 surrounding open sector 80 of keyway 74, which safeguards the mechanical space from small instruments or objects manipulating pawl 64 from the keyhole. In FIG. 7B, the components referenced in FIG. 7A are shown as assembled, with the addition of pin 72 disposed in the center of keyway 74 for better comprehension of the assembly, sharing an axis with keyway 74 and pawl 64. The spring washer 96 is now out of view, disposed below keyway 74 within the cylindrical bore of pawl 64. The keyway spur 82 hovers above lower step 98 of pawl 64, allowing for keyway 74 to drop lower in the cylindrical bore of pawl 64 when downward force is applied to keyway 74 with a conventional handcuff key. As the bottom surface of spur 82 contacts the top planar surface of lower step 98 of pawl 64, spur 82 drops below the protuberances of the housing and move with the rotation of the key. Locking stop 88 and release stop 90 of pawl 64 are also shown. A directional arrow above lower step 98 indicates the rotational movement of keyway 74. In FIG. 7C, a sectional cutaway view of the plate of housing 40 is atop the assembled components shown in FIG. 7B, comprising keyway 74, spring washer 96, pawl 64, and pin 72. Also shown are the protuberances within housing 40, consisting of outer stop 52 and inner stop 56. The spur 82 is shown seated between stop 52 and stop 56 in the stored position. The void between the stops and lower step 98, wherein spur 82 rotates and cooperates with pawl 64, is also represented.

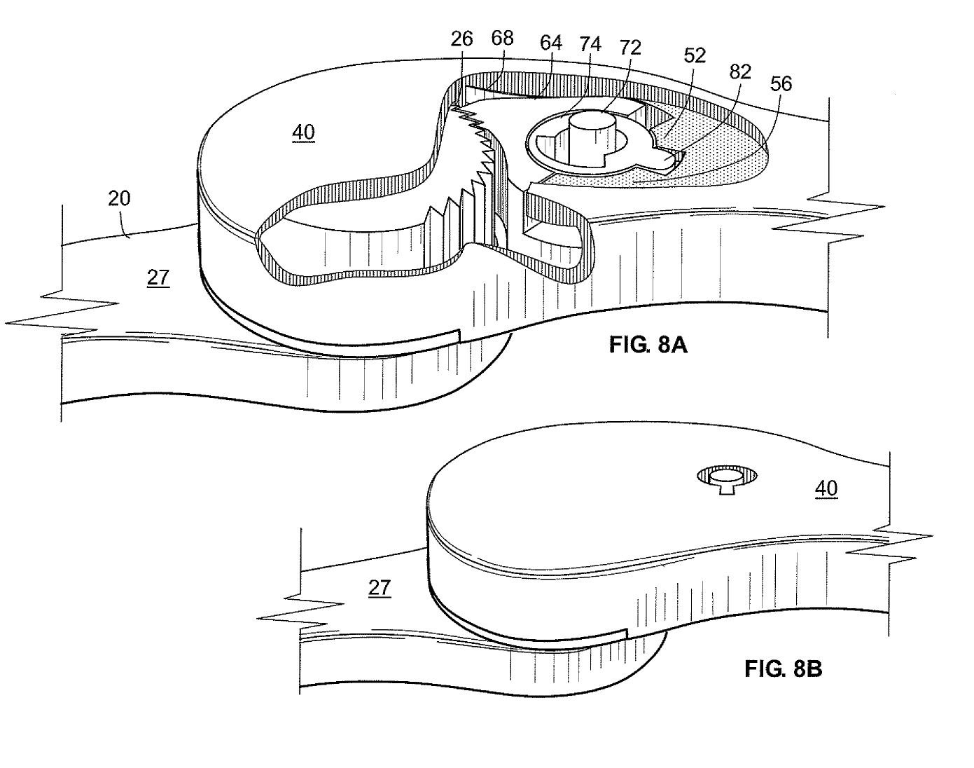

Referring to FIG. 8A-8B, the hinge area of the handcuff is shown in a perspective view, with a portion of the wall of housing 40 cut away in FIG. 8A to show mechanical components keyway 74, pawl 64, pawl spring 68, pin 72 and gear 26. Also shown is spur 82 of keyway 74 seated between inner stop 56 and outer stop 52 of housing 40 in the stored position. The top of arm 27 of frame 20 is shown as assembled.

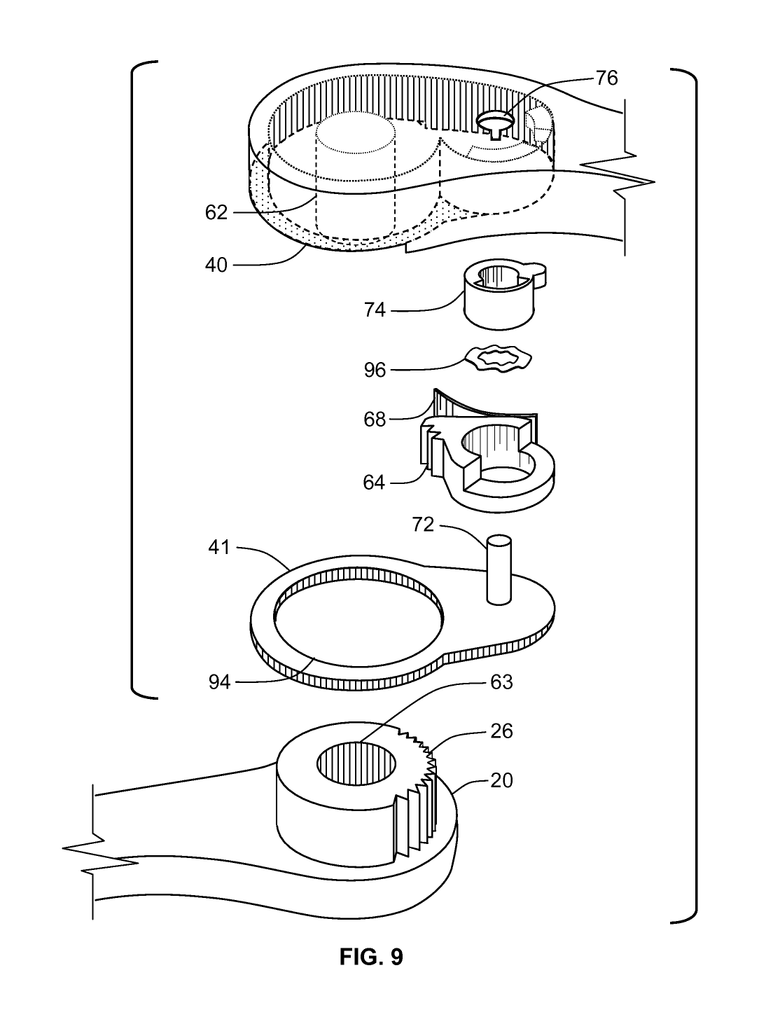

With reference to FIG. 9, the complete assembly at the hinge point for one handcuff is shown in an exploded view. Housing 40 is represented as transparent for clarity of the embodiment. The mechanical components consisting of keyway 74, spring washer 96, flat spring 68, and pawl 64 are disposed into the smaller cylindrical cavity of housing 40, centered at keyhole 76. The housing cover 41 is affixed onto housing 40, wherein pin 72 enters the cylindrical bore of keyway 74. The gear 26 affixed to frame 20 is placed into housing cover opening 94, wherein shaft 62 enters the cylindrical bore 63 of gear 26. When assembled, gear 26 is pivotally disposed into the larger cylindrical cavity of housing 40. The shaft 62 passes through the plate of frame 20 with suitable tolerance to rotate freely, and is machined pivotally to frame 20 as a complete assembly.

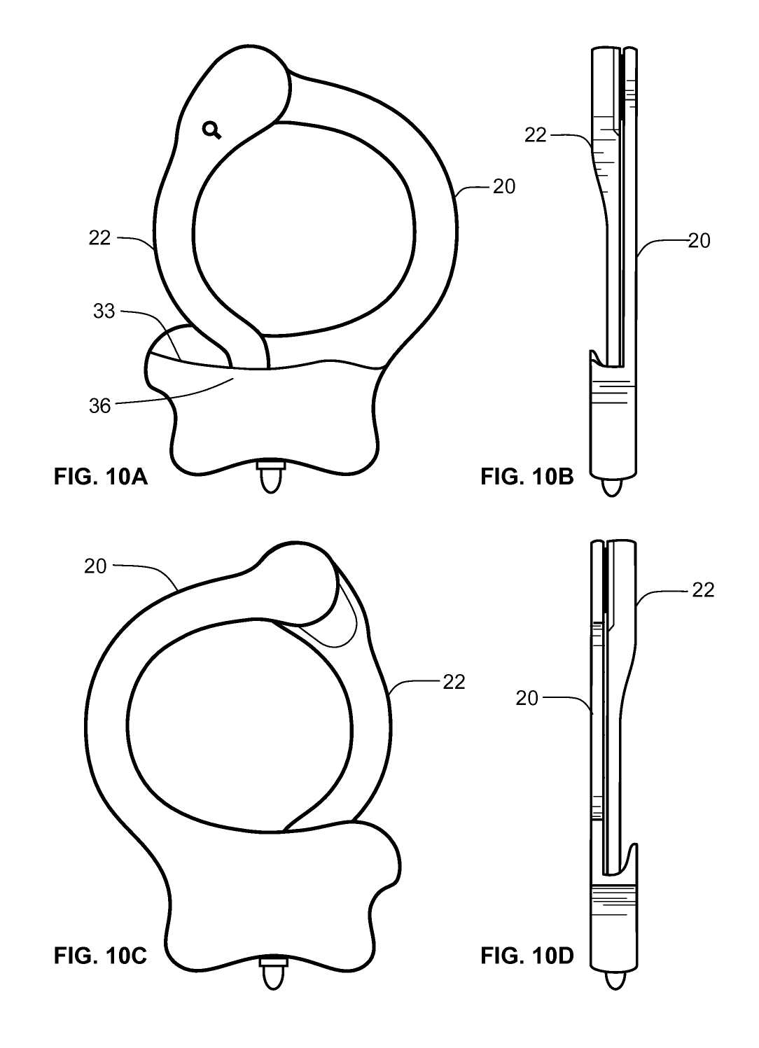

FIGS. 10A-10D show an alternative embodiment of a double locking handcuff at various angles, wherein frame 20A has base 33 with a taller arc and a recessed channel, in which arcuate tab 36 of swing arm 22 traverses frame 20A. This alternative embodiment potentially offers a higher level of security.

Although the present invention is described as a handcuff designed to block the member of or restraining an individual, its usage could be for other applications, e.g., leg restraints and shackles, or applications not related to handcuffs but within the framework and scope of this invention. Additionally, one skilled in the art will appreciate that since various additions, modifications, and substitutions could be made to the above-described invention without departing from the spirit and scope of the present invention, it is intended that the description and presently disclosed drawings of the embodiments included herein are merely examples of the concept and should not be construed as limitations to the invention.

1-12. (canceled)

13. A double locking handcuff assembly, wherein when coupled with another includes a set of handcuffs, comprising:
a frame, comprising a solid arcuate plate having a pivot point at one axial end of the plate and at the opposite axial end having a mounting point for connecting linkage and a grasping point of the plate which is ergonomically shaped for grasping by an operator using the handcuff, and whereas the inner periphery of the arcuate plate is shaped to the human anatomy and designed for gripping the wrist or ankle of a person;
a swing arm, comprising a solid arcuate plate whereas the inner periphery is shaped to the human anatomy and designed for gripping the wrist or ankle of a person;
a cylindrical gear;
a pawl;
a keyway;
a flat spring, disposed within said swing arm and configured for applying lateral bias to said pawl toward the direction of said gear;
a disc spring, disposed within said swing arm and configured for applying bias to said keyway; and
a cover, which is assembled onto said swing arm.

14. A handcuff assembly according to claim 13, wherein said swing arm comprises a housing at one axial end of the arcuate plate having:
an interior compartment defined by the housing;
a bottom floor of the compartment corresponding to the planar surface of the plate of the swing arm;
a cylindrical shaft protruding perpendicularly into the compartment from the bottom floor of the compartment, whereas the center axis of the shaft is the pivot point and rotational axis of the swing arm;
a keyhole aperture within the planar surface of the floor configured for insertion of a key into the compartment; and
at least one protuberance protruding from the floor into the compartment that cooperates with a protuberance of said keyway to prevent rotational movement of the keyway,
and which said swing arm comprises a curvilinear tab at the opposite axial end of the arcuate plate from the housing, forming a concave outer periphery of the plate at that axial end, whereas an operator using the assembled handcuff and applying force with a finger to the tab's concave surface will pivot the swing arm toward the grasping point of said frame while holding the frame at the grasping point with the same hand.

15. A handcuff assembly according to claim 13, wherein said gear is affixed to the pivot point of said frame with its axis perpendicular to the plate of the frame, and is a solid member having a hollow cylindrical bore at its axis that corresponds with the outside diameter of the cylindrical shaft of said housing of said swing arm, and its axis corresponds to the axis of the pivoting point of the swing arm and is rotatably disposed within the compartment of the housing of the swing arm, comprising:
a ratcheting segment of the circumference formed with a plurality of teeth that extend between opposite axial ends of the gear and parallel to the axis, having stops and slopes that permit unidirectional rotation when engaged with the cooperating teeth of said pawl, and wherein the bottom of the troughs between the teeth define a first arc having a first radius and the tips of the teeth define a second arc having a second radius larger than the first radius; and
a smooth surface of the circumference analogous to the first or second radius encompassing the remaining circumference of the gear wherein a free rotating segment is formed.

16. A handcuff assembly according to claim 13, wherein said pawl is a solid member with top and bottom planar surfaces having a hollow cylindrical bore perpendicular to its plane that corresponds with the outer diameter of said keyway, and whereas the center of the bore is the axis of the pawl which corresponds with the axis of the keyway, and comprising one or more teeth that extend between opposite ends of the planar surfaces which face and cooperate with the ratcheting segment of said gear when biased by said flat spring, and comprises a surface for manipulation by the keyway when applying force to that surface to effect movement of the pawl.

17. A handcuff assembly according to claim 16, wherein said pawl is pivotally disposed within said housing compartment of said swing arm with respect to said gear between:
a position against the gear wherein:
unidirectional rotational movement occurs while the teeth of the pawl are engaged with the teeth of the gear; and
free rotational movement in either direction occurs while the teeth are in contact with the smooth circumference of the gear, or
a position disconnected from the gear when rotating said keyway by way of a key, wherein the protuberance of the keyway contacts and pivotally shifts the pawl on its axis against the bias of said flat spring away from the gear.

18. A handcuff assembly according to claim 13, wherein said keyway is cylindrical and is rotatably disposed within said housing compartment of said swing arm with an axis corresponding with the axis of the circular aperture of the keyhole in the housing of said swing arm, having:
a hollow cylindrical bore through the axis of the keyway cylinder extending to its axial ends and forming an inner cylinder wall of the keyway, whereas the diameter of the bore cooperates with the diameter of a key shaft; and
a void in a sector of the inner cylinder wall configured for the bit of a key to extend perpendicularly to the axis of the cylinder into the void and pivot within the void.

19. A handcuff assembly according to claim 18, wherein said keyway has a protuberance projecting outward from the outer periphery of the cylinder perpendicular to the axis of the keyway, wherein:
the protuberance of the keyway prevents rotation of the keyway when seated between protuberances within said housing compartment of said swing arm while bias by said disc spring is applied to the keyway toward the floor of the compartment;
the protuberance of the keyway is disengaged from between protuberances of the housing compartment by the application of force onto the keyway by way of a key against the bias of the disc spring, wherein the keyway is freely rotational; and
the keyway protuberance effects pivotal movement of said pawl when the keyway is rotated by way of a key and applies force to a surface of the pawl.

20. A handcuff assembly according to claim 13, wherein said cover is a solid plate defined by said housing of said swing arm, comprising a cylindrical shaft extending perpendicularly from the planar surface of the plate, wherein the shaft:
extends through the cavity of said housing compartment when assembled to the swing arm;
corresponds to the axis of said keyway; and
has a diameter which corresponds to and cooperates with the hollow shaft of a key,
and whereas the plate forms a top planar surface of said housing of said swing arm and encloses the housing compartment.

21. A handcuff assembly according to claim 13, wherein said gear, said pawl, and said keyway are situated in said housing compartment of said swing arm on the opposite axial end from the grasping point of the handcuff, and whereas the housing is situated at the pivoting point of two curvilinear plates designed for gripping a wrist or ankle of a person without a mechanical union of the plates at the opposite axial ends.

22. A handcuff assembly according to claim 21, whereas referring to a set of handcuffs joined by connecting linkage, said housing of said swing arm of one handcuff is at the opposite axial end of the housing of the swing arm of its adjoined handcuff when the set is extended directly outward.

23. A handcuff assembly according to claim 13, wherein said frame is assembled rotatably to said swing arm at their corresponding pivot points, whereas the plate of the swing arm rotates in parallel to the plate of the frame.
